(19) United States
(12) Patent Application Publication
(10) Pub. No.: US 2024/0369990 A1
(43) Pub. Date: Nov. 7, 2024

(54) METHODS, APPARATUSES, AND COMPUTER PROGRAM PRODUCTS FOR PROCESS FLOW DIAGRAM CREATION AND EMBEDDING INSIDE CLOUD-HOSTED PROCESS SIMULATION SYSTEM LIVE WEB APPLICATION

(71) Applicant: Honeywell International Inc., Charlotte, NC (US)

(72) Inventors: Vijayamahantesh Karpurmath, Bangalore (IN); Abhishek Pednekar, Des Plaines, IL (US); John Goodman, Houston, TX (US); Palavesh Kalyanasundaram, Bangalore (IN); Alexander Petrov, Sofia (BG)

(21) Appl. No.: 18/212,524

(22) Filed: Jun. 21, 2023

(30) Foreign Application Priority Data
May 3, 2023 (IN) 202311031544

(51) Int. Cl. G05B 19/4097

(52) U.S. Cl. CPC G05B 19/4097; G05B 2219/31449

(57) ABSTRACT

Methods, apparatuses, and computer program products for generating a process flow diagram that digitally represents one or more assets of a process or subprocess within an industrial environment are provided. For example, a computer-implemented method may include receiving a first graphic representation of the process or subprocess and one or more assets of the process or subprocess, accessing a data model database corresponding to the process or subprocess and the one or more assets of the process or subprocess, converting the first graphic representation into a second graphic representation linked to the data model database and including values from the data model database for one or more attributes corresponding to the one or more assets, and storing the second graphic representation in one or more servers or one or more cloud computing devices and providing web browser access to the second graphic representation by one or more user devices.

### CROSS-REFERENCE TO RELATED APPLICATIONS

This application claims priority to and the benefit of foreign India patent application Ser. No. 202311031544, filed on May 3, 2023 and entitled “Methods, Apparatuses, and Computer Program Products For Process Flow Diagram Creation and Embedding Inside Cloud-Hosted Process Simulation System Live Web Application,” which is incorporated herein by reference in its entirety.

### TECHNICAL FIELD

The present disclosure generally relates to process flow diagrams related to industrial assets in an industrial environment, and more particularly to process flow diagram creation inside a process simulation system live web application.

### BACKGROUND

An industrial environment generally includes physical assets such machines, sensors, equipment, computing devices, and/or other types of industrial assets configured to execute one or more industrial processes. Process simulation tools, such as asset models and process digital twin systems, are often used to model and/or monitor such industrial environments.

However, Applicant has discovered many technological inefficiencies related to such traditional asset models.

### BRIEF SUMMARY

The details of some embodiments of the subject matter described in this specification are set forth in the accompanying drawings and the description below. Other features, aspects, and advantages of the subject matter will become apparent from the description, the drawings, and the claims.

In accordance with a first aspect of the disclosure, a computer-implemented method for generating a process flow diagram that digitally represents one or more assets of a process or subprocess within an industrial environment is provided. In at least one example embodiment, an example method comprises receiving a first graphic representation of the process or subprocess and the one or more assets of the process or subprocess, accessing a data model database corresponding to the process or subprocess and the one or more assets of the process or subprocess, the data model database comprising a time series database comprising values for one or more attributes corresponding to the one or more assets of the process or subprocess at a plurality of different times, converting the first graphic representation into a second graphic representation of the process or subprocess and the one or more assets of the process or subprocess, the second graphic representation linked to the data model database and including values from the data model database for one or more of the attributes corresponding to the one or more assets of the process or subprocess, the second graphic representation formatted to enable web browser access, and storing the second graphic representation in one or more servers or one or more cloud computing devices and providing web browser access to the second graphic representation by one or more user devices.

In some embodiments, the one or more assets of the process or subprocess comprise equipment, streams, measurement instruments, calculated values, inputs and/or outputs.

In some embodiments, the first graphic representation comprises a training simulator graphic representation of the process or subprocess or a distributed control system console graphic representation of the process or subprocess.

In some embodiments, the displayed values from the data model database comprise live data from the industrial environment and/or calculated data.

In some embodiments, at least some of the one or more attributes enable preprocessing calculations, postprocessing calculations, storing inputs to the preprocessing and/or postprocessing calculations, storing results from the preprocessing and/or postprocessing calculations, measurement values from the industrial environment, parameter values to support the preprocessing and/or postprocessing calculations, and/or simulation results.

In some embodiments, the second graphic representation is linked to the data model database via an application program interface.

In some embodiments, the second graphic representation is user-editable.

In accordance with another aspect of the disclosure, an apparatus for generating a process flow diagram that digitally represents one or more assets of a process or subprocess within an industrial environment is provided. The apparatus comprises at least one processor and at least one non-transitory memory comprising program code. The at least one non-transitory memory and the program code are configured to, with the at least one processor, cause the apparatus to at least receive a first graphic representation of the process or subprocess and the one or more assets of the process or subprocess, access a data model database corresponding to the process or subprocess and the one or more assets of the process or subprocess, the data model database comprising a time series database comprising values for one or more attributes corresponding to the one or more assets of the process or subprocess at a plurality of different times, convert the first graphic representation into a second graphic representation of the process or subprocess and the one or more assets of the process or subprocess, the second graphic representation linked to the data model database and including values from the data model database for one or more of the attributes corresponding to the one or more assets of the process or subprocess, the second graphic representation formatted to enable web browser access, and store the second graphic representation in one or more servers or one or more cloud computing devices and provide web browser access to the second graphic representation by one or more user devices.

In accordance with yet another aspect of the disclosure, an example computer program product is provided. The example computer program product includes at least one non-transitory computer-readable storage medium having computer-readable program code portions stored therein, the computer-readable program code portions comprising an executable portion configured to at least receive a first graphic representation of the process or subprocess and the one or more assets of the process or subprocess, access a data model database corresponding to the process or subprocess and the one or more assets of the process or subprocess, the data model database comprising a time series database comprising values for one or more attributes corresponding to the one or more assets of the process or subprocess at a plurality of different times, convert the first graphic representation into a second graphic representation of the process or subprocess and the one or more assets of the process or subprocess, the second graphic representation linked to the data model database and including values from the data model database for one or more of the attributes corresponding to the one or more assets of the process or subprocess, the second graphic representation formatted to enable web browser access, and store the second graphic representation in one or more servers or one or more cloud computing devices and provide web browser access to the second graphic representation by one or more user devices.

### BRIEF DESCRIPTION OF THE SEVERAL VIEWS OF THE DRAWINGS

Having thus described the embodiments of the disclosure in general terms, reference now will be made to the accompanying drawings, which are not necessarily drawn to scale, and wherein:

FIG. 1 illustrates a block diagram of a system that may be specially configured within which embodiments of the present disclosure may operate;

FIG. 2 illustrates a block diagram of an example apparatus that may be specially configured in accordance with an example embodiment of the present disclosure;

FIG. 3 illustrates a flow chart for automatically generating a cloud-hosted process flow diagram, in accordance with an example embodiment of the present disclosure;

FIG. 4 illustrates a graphical representation of an industrial process for which a cloud-hosted process flow diagram may be created, in accordance with an example embodiment of the present disclosure;

FIG. 5 is an alternative view of the graphical representation of FIG. 4;

FIG. 6 illustrates a shape library for automatically generating a cloud-hosted process flow diagram, in accordance with an example embodiment of the present disclosure;

FIG. 7 illustrates a shape configuration screen for automatically generating a cloud-hosted process flow diagram, in accordance with an example embodiment of the present disclosure; and

FIG. 8 illustrates a cloud-hosted process flow diagram, in accordance with an example embodiment of the present disclosure.

### DETAILED DESCRIPTION

Embodiments of the present disclosure now will be described more fully hereinafter with reference to the accompanying drawings, in which some, but not all, embodiments of the disclosure are shown. Many modifications and other embodiments of the disclosure set forth herein will come to mind to one skilled in the art to which this disclosure pertains having the benefit of the teachings presented in the foregoing description and the associated drawings. Therefore, it is to be understood that the embodiments are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

The term “or” is used herein in both the alternative and conjunctive sense, unless otherwise indicated. Terms such as “computing,” “determining,” “generating,” and/or similar words are used herein interchangeably to refer to the creation, modification, or identification of data. Further, “based on,” “based on in part on,” “based at least on,” “based upon,” and/or similar words are used herein interchangeably in an open-ended manner such that they do not indicate being based only on or based solely on the referenced element or elements unless so indicated. Like numbers refer to like elements throughout.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

The term “industrial plant,” “plant,” and/or similar terms used herein interchangeably may refer to one or more buildings, complex, or arrangement of components that perform a chemical, physical, electrical, mechanical process, and/or the like for converting input materials into one or more output products. Non-limiting examples of an industrial plant include a chemical industrial plant, automotive manufacturing plant, distillery, oil refinery, fabric manufacturing plant, and/or the like.

The term “physical component” with respect to an industrial plant may refer to asset(s) within or associated with the industrial plant. Such assets, for example, may include real-world equipment, systems, or other physical structures within and/or associated with the industrial plant, and that is utilized by the industrial plant. For example, a physical component with respect to an industrial plant may comprise equipment, systems, or other structures that are utilized in a process performed by the industrial plant. In an example context of an oil refinery, non-limiting examples of a physical component may include a furnace, a pump, a heat exchanger, a distillation column, and/or the like.

The term “process simulation model,” which may also be termed a “data model” or an “asset model,” refers to a model-based representation of one or more processes of an industrial plant. A process simulation model may be configured to facilitate designing, developing, analyzing, monitoring, controlling, optimizing, and/or the like one or more processes of the industrial plant. Such processes for example, may include chemical processes, biological processes, and/or the like. In one or more embodiments, a process simulation model embodies a process flow diagram that describes the process flow through an industrial plant. A non-limiting example of a process simulation model is a first principle-based simulation model that models equipment and/or processes based on fundamental laws of physics, thermodynamics, kinetics, chemistry, etc. For example, a feed stream associated with a gas refrigeration plant may be defined in a process simulation model in terms of its physical and/or chemical properties. As another example, a feed stream associated with a crude oil processing plant may be defined in a process simulation model in terms of its physical and/or chemical properties. One or more inputs to a process simulation model may be fixed input(s), while one or more inputs to the process simulation model may be variable input(s). Additionally or alternatively, one or more inputs to the process simulation model may be a computed value, for example, by the process simulation model. Additionally or alternatively, one or more inputs to the process simulation model may comprise data received from the plant. As a non-limiting example, such data received from the plant may comprise equipment and/or process variable measurements (e.g., sensor-based measurements). In one or more embodiments, execution of a process simulation model includes performing one or more operations. As a non-limiting example, the one or more operations may include an optimization operation with respect to one or more objective functions (e.g., minimum energy, maximum production, maximum profit, minimum cost, and/or the like) in order to determine optimal operating points/conditions for specified parameter(s). An optimal operating point/condition for a specified parameter, for example, may describe a stable operating point/condition for the specified parameter. In some embodiments, a process simulation model may comprise a steady-state model or a dynamic model. For example, in some embodiments a process simulation model may simulate a steady state process and/or a dynamic process. In some embodiments, a process simulation model may be associated with or otherwise embodied by a digital twin model.

A process simulation model may include hundreds or thousands of assets, and one or more “attributes” may be associated with each asset. The attributes define a particular feature or value related to the asset. The attributes may comprise, for example, raw data values that are measured in the plant, such as temperature and flow; values that are used for calculations within the model, such as conversion factors or constants; the results of intermediate or final calculations; or simulation or optimization results.

A “process flow diagram” (PFD) is a graphic representation of a process flow through an industrial plant. A process simulation model is often created from a process flow diagram. A process flow diagram often includes or is linked to one or more “process data tables.” A process flow diagram may include one or more input data tables defining the inputs to the process simulation model and one or more output data tables defining the outputs from the process simulation model. A process flow diagram may include a source data table that indicates which variables from the industrial plant should be mapped to which inputs.

A process simulation model may rely on a “time-series database” (TSDB), and such a TSDB is often created as part of creating a process simulation model. Many, if not most, of the attribute values of a process simulation model change over time. Such a TSDB records the values of the attributes at different times. Depending on the state of the plant and the process models, the time intervals at which the attributes are recorded may vary.

A “digital twin model,” “process digital twin,” “process digital twin system,” and the like refers to a digital, model-based representation of physical components (e.g., equipment, system, processes, etc.) in operation. In one or more embodiments, a digital twin model is configured to run with plant data in that incoming data (e.g., operational data) from the plant is fed into the digital twin model to update the model. As such, a digital twin model may describe a representation of equipment and/or processes of an industrial plant that reflects the current operating conditions. A digital twin model may be used to monitor, refine, control, predict, and/or optimize operations of the industrial plant. In some embodiments, the digital twin model may comprise one or more process simulation models and/or one or more data-driven models.

“Cloud-hosted” refers to a resource (for example, an application, website, etc.) that resides on a server or other computing device that is accessible to remote users via the internet or other network. A cloud-hosted resources may be publicly accessible to any internet connected device or may be access-restricted such that only authorized users may access the resource. Cloud-hosted resources are typically formatted to enable access to the resource via a standard web browser.

In at least some conventional training simulator systems, a process flow diagram that digitally represents one or more assets of a process or subprocess within an industrial environment is displayed for a user. At least some such training simulator systems run on a user's local computer (i.e., as a “desktop application”) such that the displayed process flow diagram is tied to the user's desktop and displays only information from the desktop simulator.

Various embodiments of the present disclosure address technical challenges related to generating a process flow diagram that digitally represents one or more assets of a process or subprocess within an industrial environment. Specifically, embodiments of the present disclosure enable generating a cloud-hosted process flow diagram that is formatted to enable web browser access to the process flow diagram.

Embodiments of the present disclosure receive a first graphic representation of the process or subprocess and the one or more assets of the process or subprocess. In some embodiments, the first graphic representation is a process flow diagram from a desktop-bound training simulator system or distributed control system (DCS). In some embodiments, the assets of the process or subprocess include one or more of equipment, streams, measurement instruments, calculated values, inputs and/or outputs.

Embodiments of the present disclosure also access a process simulation model database corresponding to the process or subprocess and the one or more assets of the process or subprocess. In some embodiments, the process simulation model database comprises a time series database (TSDB) comprising values for one or more attributes corresponding to the assets at a plurality of different times. In some embodiments, the TSDB is cloud-hosted. In some embodiment, the TSDB includes attribute values that are measured at and received from the industrial environment. In some embodiment, the TSDB includes attribute values that are calculated or otherwise derived by the process simulation model.

Embodiments of the present disclosure convert the first graphic representation into a second graphic representation of the process or subprocess and the assets. In some embodiments, the second graphic representation is linked to the process simulation model database (i.e., the TSDB). In some embodiments, the second graphic representation is formatted to enable web browser access. In some embodiments, the second graphic representation displays attribute values from the TSDB that are measured at and received from the industrial environment. In some embodiment, the second graphic representation displays attribute values from the TSDB that are calculated or otherwise derived by the process simulation model.

Embodiments of the present disclosure store the second graphic representation in one or more servers or one or more cloud computing devices and enable web browser access to the second graphic representation by one or more user devices over a network.

Embodiments of the present disclosure herein include systems, apparatuses, methods, and computer program products that enable generating a cloud-hosted process flow diagram that is formatted to enable web browser access to the process flow diagram. It should be readily appreciated that the embodiments of the apparatus, systems, methods, and computer program product described herein may be configured in various additional and alternative manners in addition to those expressly described herein.

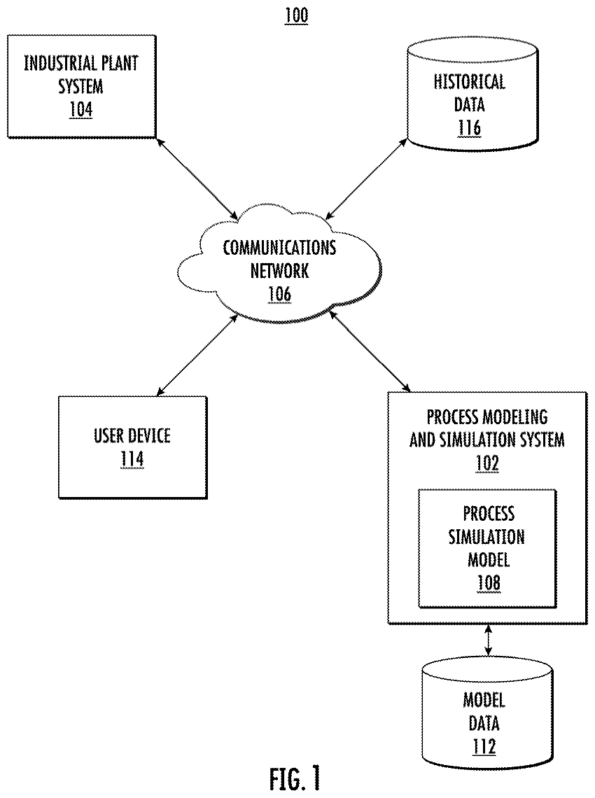

FIG. 1 illustrates a block diagram of an environment/system 100 in which embodiments of the present disclosure may operate. Specifically, FIG. 1 illustrates an industrial plant system 104 system in communication with a process modeling and simulation system 102. In some embodiments, the industrial plant system 104 communicates with the process modeling and simulation system 102 over one or more communication network(s), for example a communications network 106. In some embodiments, the industrial plant system 104 is in communication with a plurality of plant systems, each identically or similarly configured to the industrial plant system 104. In some such embodiments, the process modeling and simulation system 102 may process data associated with each industrial plant system 104 independently, and/or in some contexts processes data associated with multiple industrial plant systems 104 in the aggregate (e.g., when processing all industrial plant systems 104 associated with a particular entity, region, and/or the like). In some embodiments, the process modeling and simulation system 102 includes one or more process simulation models 108. The one or more process simulation models may at least in part represent a digital twin model. For example, in some embodiments, the process modeling and simulation system 102 may comprise a digital twin model that is the process simulation model 108 or may comprise a digital twin model that includes one or more process simulation models 108 and/or one or more data-driven models. As depicted in FIG. 1, in some embodiments, the process modeling and simulation system 102 includes one or more process simulation models 108. As further depicted in FIG. 1, in some embodiments, the process modeling and simulation system 102 includes a model data storage system 112 that may be external (as illustrated) or internal to the process modeling and simulation system 102. For example, the model data storage system 112 may be comprise a part of a separate system in communication with the process modeling and simulation system 102 (e.g., via the communications network 106).

As depicted in FIG. 1, in some embodiments, the process modeling and simulation system 102 may be in communication with a historical data storage system 116 that may be external (as illustrated) or internal to the process modeling and simulation system 102. For example, the historical data storage system 116 may be a part of a separate system in communication with the process modeling and simulation system 102 (e.g., via the communications network 106). In some embodiments, the historical data storage system 116 comprises a cloud historian collector (CHC) that uses a Laboratory Information Management System (LIMS) database that stores historical values for one or more of the asset attribute values from the industrial plant system 104.

As depicted in FIG. 1, in some embodiments, the process modeling and simulation system 102 may be in communication with a user device 114 that may be external (as illustrated) or internal to the process modeling and simulation system 102. In some embodiments, the user device 114 enables a user to create and interact with a process simulation model.

It should be appreciated that the communications network 106 in some embodiments is embodied in any of a myriad of network configurations. In some embodiments, the communications network 106 embodies a public network (e.g., the Internet). In some embodiments, the communications network 106 embodies a private network (e.g., an internal localized, or closed-off network between particular devices). In some other embodiments, the communications network 106 embodies a hybrid network (e.g., a network enabling internal communications between particular connected devices and external communications with other devices). The communications network 106 in some embodiments includes one or more base station(s), relay(s), router(s), switch(es), cell tower(s), communications cable(s) and/or associated routing station(s), and/or the like. In some embodiments, the communications network 106 includes one or more user controlled computing device(s) (e.g., a user owned router and/or modem) and/or one or more external utility devices (e.g., Internet service provider communication tower(s) and/or other device(s)).

In some embodiments, each of the components of the system 100 communicatively are coupled to transmit data to and/or receive data from one another over the same or different wireless and/or wired networks embodying the communications network 106. Such configuration(s) include, without limitation, a wired or wireless Personal Area Network (PAN), Local Area Network (LAN), Metropolitan Area Network (MAN), Wide Area Network (WAN), and/or the like. Additionally, while FIG. 1 illustrate certain system entities as separate, standalone entities communicating over the communications network 106, the various embodiments are not limited to this architecture. In other embodiments, one or more computing entities share one or more components, hardware, and/or the like, or otherwise are embodied by a single computing device such that connection(s) between the computing entities are over the communications network 106 are altered and/or rendered unnecessary. For example, in some embodiments, the industrial plant system 104 includes some or all of the process modeling and simulation system 102, such that an external communications network 106 is not required.

In some embodiments, the industrial plant system 104 and the process modeling and simulation system 102 are embodied in an on-premises system within or associated with the industrial plant. In some such embodiments, the industrial plant system 104 and the process modeling and simulation system 102 are communicatively coupled via at least one wired connection. Alternatively or additionally, in some embodiments, the industrial plant system 104 embodies or includes the process modeling and simulation system 102, for example as a software component of a single enterprise terminal.

The industrial plant system 104 includes any number of computing device(s), system(s), physical component(s), and/or the like, that facilitates producing of any number of products, for example utilizing particular configurations that cause processing of particular inputs available within the industrial plant system 104. In some embodiments, the industrial plant system 104 includes one or more physical component(s), connection(s) between physical component(s), and/or computing system(s) that control operation of each physical component therein. In some embodiments, a physical component describes asset(s) within or associated with an industrial plant. Such assets, for example, may include real-world equipment, systems, or other physical structures within and/or associated with the industrial plant, and that is utilized by the industrial plant. For example, a physical component with respect to an industrial plant may comprise equipment, systems, or other structures that are utilized in a process performed by the industrial plant. In an example context of an oil refinery plant, non-limiting examples of a physical component may include a furnace, a pump, a heat exchanger, and/or the like. The industrial plant system 104, for example, can embody an oil refinery, an automotive engine manufacturing plant, a distillery, and/or the like, which includes physical component(s) that perform particular process(es) to alter properties of inputs to the component(s). Additionally or alternatively, in some embodiments the industrial plant system 104 includes one or more computing system(s) that are specially configured to operate the physical component(s) in a manner that produces one or more particular product(s) simultaneously. In some embodiments, an industrial plant system 104 includes one or more computing device(s) and/or system(s) embodied in hardware, software, firmware, and/or a combination thereof, that configure and/or otherwise control operation of one or more physical component(s) in the corresponding industrial plant(s). For example, in some embodiments, such computing device(s) and/or system(s) include one or more programmable logic controller(s), MPC(s), application server(s), centralized control system(s), and/or the like, that control(s) configuration and/or operation of at least one physical component. It will be appreciated that different industrial plant system(s) may include or otherwise be associated with different physical component(s), computing system(s), and/or the like.

The process modeling and simulation system 102 includes one or more computing device(s) and/or system(s) embodied in hardware, software, firmware, and/or a combination thereof, that can model and/or simulate process(es) associated with an industrial plant. In some embodiments, the process modeling and simulation system 102 includes one or more specially configured application server(s), database server(s), end user device(s), cloud computing system(s), and/or the like. Additionally or alternatively, in some embodiments, the process modeling and simulation system 102 includes one or more user device(s) that enables access to functionality provided by the process modeling and simulation system 102, for example via a web application, native application, and/or the like. For example, in some embodiments, the process modeling and simulation system 102 provides cloud-based functionality to an end-user that facilitates cloud-based monitoring, controlling, optimization, etc., of an industrial plant system, such as industrial plant system 104

The process modeling and simulation system 102 can be used for, for example, designing, analyzing, monitoring, controlling, and/or optimizing an industrial plant. In one or more embodiments, the process modeling and simulation system 102 is configured to output data that reflects optimal operating points/conditions for one or more specified parameters associated with an equipment and/or process of an industrial plant, such as an industrial plant embodied by the industrial plant system 104. For example, the process modeling and simulation system 102, can be configured to perform, based at least in part on input data associated with the industrial plant, one or more modeling operations and/or simulation operations that facilitates generation of model-predicted data, wherein the model predicted prediction(s) may be used to facilitate designing, analyzing, monitoring, controlling, and/or optimizing equipment and/or process(es) of an industrial plant. In some embodiments, the process modeling and simulation system 102 includes one or more application server(s) and/or database server(s) that provide such functionality. Additionally or alternatively, in some embodiments, the process modeling and simulation system 102 includes one or more client device(s), user device(s), and/or the like, such as user device 114, that enable access to the functionality provided via the process modeling and simulation system 102, for example via a web application, a native application, and/or the like executed on the client device. In some embodiments, the process modeling and simulation system 102 includes or embodies a display or other user interface to which a user-facing interface is renderable.

In some embodiments, the process modeling and simulation system 102 and industrial plant system 104 communicate with one another to perform the various actions described herein. For example, in some embodiments, the process modeling and simulation system 102 and the industrial plant system 104 communicate in order to generate model-predicted data associated with operation of the industrial plant (e.g., embodied by the industrial plant system 104). Additionally or alternatively, in some embodiments, the process modeling and simulation system 102 and the industrial plant system 104 communicate to facilitate control or adjustment of operation of physical component(s) in the industrial plants based at least in part on the generated model-predicted data. For example, in some embodiments the process modeling and simulation system 102 and the industrial plant system 104 can communicate to automatically configure or reconfigure one or more physical component(s) of the industrial plant based on the model-predicted data. In some embodiments, the process modeling and simulation system 102 includes a process simulation model 108. In some embodiments, the process modeling and simulation system 102 includes a plurality of process simulation models 108.

In some embodiments, a process simulation model 108 is a model-based representation of one or more assets of an industrial plant (e.g., industrial plant embodied by the industrial plant system 104). A process simulation model 108 may comprise one or more asset models, that each represent an asset associated with the industrial plant system 104. An asset may include equipment and/or processes associated with the industrial plant system 104 (e.g., industrial plant thereof) and/or their units. One or more inputs to process simulation model 108 may be fixed input(s), while one or more inputs to process simulation model 108 may be variable input(s). Additionally or alternatively, one or more inputs to the process simulation model may be a computed value. In one or more embodiments, an input to the process simulation model 108 that is a computed value is determined (e.g., computed) by the process simulation model 108 embodied by the process modeling and simulation system 102. Additionally or alternatively, one or more inputs to the process simulation model may comprise data received from the industrial plant system 104. Such data (e.g., plant data) may comprise operational data received from the plant, such as process variable measurements and/or equipment variable measurements. In an example context, one or more equipment and/or processes associated with the industrial plant system 104 may include sensor devices for measuring certain variables (e.g., temperature, pressure, etc.) with respect to the equipment and/or processes. In some embodiments, a particular process simulation model 108 may be a first principle-based simulation model that models equipment and/or processes based on fundamental laws of physics, thermodynamics, kinetics, chemistry, etc. For example, a feed stream associated with a gas refrigeration plant, or a crude oil processing plant may be defined in the process simulation model 108 in terms of its physical and/or chemical properties. Additionally or alternatively, one or more inputs to the process simulation model may comprise historical data related to the industrial plant system 104, such as from a historical data storage system 116. Such historical data may comprise operational data, such as process variable measurements and/or equipment variable measurements, captured from the plant over a prior predetermined time period.

In one or more embodiments, process simulation model 108 can implement an algorithm based on inter-related asset models for the industrial plant (e.g., embodied by the industrial plant system 104) to model and/or simulate assets of the plant, and to generate prediction(s). In some embodiments, prediction(s) may comprise model-predicted data that represent or otherwise reflect predicted plant performance, comparison of current plant performance against historical plant performance to detect changes associated with operation of the plant such as changes in equipment and/or process(es). Additionally or alternatively, the model-predicted data may comprise data indicative of operating points/condition(s) for one or more equipment and/or process variables. In one or more embodiments, process simulation model 108 may facilitate designing, developing, analyzing, monitoring, controlling, optimizing, and/or the like of one or more equipment and/or processes of the industrial plant. Such processes, for example, may include chemical processes, biological processes, and/or the like. In one or more embodiments, process simulation model 108 embodies a process flow diagram that describes the process flow through the industrial plant.

In one or more embodiments the process modeling and simulation system 102 and/or the process simulation model 108 may represent a digital twin (e.g., digital twin model) with respect to an industrial plant embodied by the industrial plant system 104. For example, as described above, in one or more embodiments, the process simulation model 108 is a digital twin model of one or more processes of the industrial plant. For example, in some examples, the process modeling and simulation system 102 comprises a digital twin model that is a process simulation model 108. In some examples, the process modeling and simulation system 102 comprises a digital twin model that includes one or more process simulation. A digital twin model with respect to an industrial plant may describe a model-based representation of physical components (e.g., equipment, system, processes, etc.) in operation. The digital twin model (e.g., process simulation model 108 thereof) may be configured to run with plant data in that incoming data from the plant is fed into the digital twin model to update the model. As described above, plant data (e.g., operational data) may include measurements of one or more measured process variables and/or equipment variables. As such, a digital twin model may describe at least in part a representation of equipment and/or processes of an industrial plant that reflects the current operating conditions, and may be used to monitor, refine, control, predict, and/or optimize operations of the industrial plant. Additionally or alternatively, the digital twin model may be used to collect and store various data associated with the operation of the industrial plant.

In one or more embodiments, execution of a process simulation model 108 includes performing one or more operations to output prediction(s) (e.g., model-predicted data) that reflect operation of the industrial plant embodied by the industrial plant system 104, and that in turn can be used for monitoring, controlling, analyzing, and/or optimizing equipment and processes of the industrial plant. As a non-limiting example, the one or more operations may include an optimization operation with respect to one or more optimization objective functions (e.g., minimum energy, maximum production, maximum profit, minimum cost, and/or the like) and/or constraints in order to determine optimal operating points/conditions for specified parameter(s). An optimal operating point/condition for a specified parameter, for example, may describe a stable operating point/condition for the specified parameter. Non-limiting examples of constraints with respect to an optimization operation include physical equipment limits, safe operating limits, product quality specifications, product flows (minimum or maximum limits), energy use, feed availability, and/or the like. In some embodiments, a process simulation model 108 may comprise a steady-state model or a dynamic model in that the process simulation model 108 may be a steady state representation or dynamic representation of process(es) of and industrial plant.

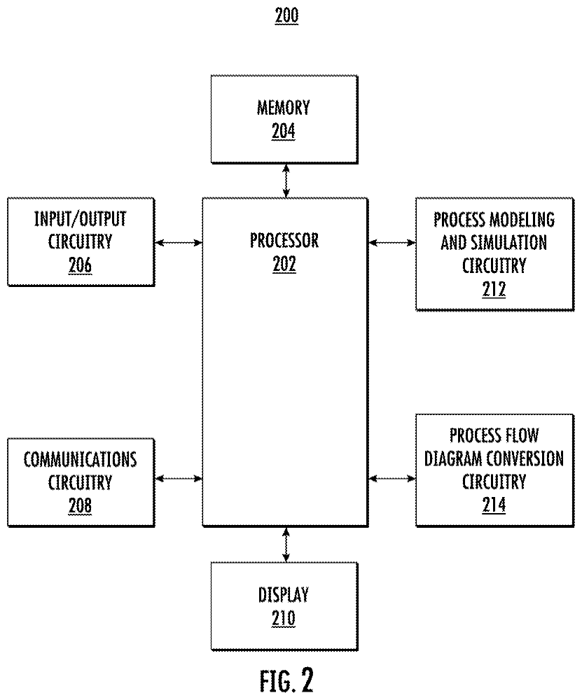

FIG. 2 illustrates a block diagram of an example apparatus that may be specially configured in accordance with an example embodiment of the present disclosure. Specifically, FIG. 2 depicts an example computing apparatus 200 specially configured in accordance with at least some example embodiments of the present disclosure. In some embodiments, the process modeling and simulation system 102, and/or a portion thereof is embodied by one or more system(s), such as the apparatus 200 as depicted and described in FIG. 2. The apparatus 200 includes processor 202, memory 204, input/output circuitry 206, communications circuitry 208, display 210, process modeling and simulation circuitry 212, and process flow diagram conversion circuitry 214. In some embodiments, the apparatus 200 is configured, using one or more of the sets of circuitry 202-214 to execute and perform the operations described herein.

In general, the terms computing entity (or “entity” in reference other than to a user), device, system, and/or similar words used herein interchangeably may refer to, for example, one or more computers, computing entities, desktop computers, mobile phones, tablets, phablets, notebooks, laptops, distributed systems, items/devices, terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In some embodiments, these functions, operations, and/or processes can be performed on data, content, information, and/or similar terms used herein interchangeably. In this regard, the apparatus 200 embodies a particular, specially configured computing entity transformed to enable the specific operations described herein and provide the specific advantages associated therewith, as described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), network interface(s), storage medium(s), and/or the like, to perform their associated functions, such that duplicate hardware is not required for each set of circuitry. The use of the term “circuitry” as used herein with respect to components of the apparatuses described herein should therefore be understood to include particular hardware configured to perform the functions associated with the particular circuitry as described herein.

Particularly, the term “circuitry” should be understood broadly to include hardware and, in some embodiments, software for configuring the hardware. For example, in some embodiments, “circuitry” includes processing circuitry, storage media, network interfaces, input/output devices, and/or the like. Alternatively or additionally, in some embodiments, other elements of the apparatus 200 provide or supplement the functionality of another particular set of circuitry. For example, the processor 202 in some embodiments provides processing functionality to any of the sets of circuitry, the memory 204 provides storage functionality to any of the sets of circuitry, the communications circuitry 208 provides network interface functionality to any of the sets of circuitry, and/or the like.

In some embodiments, the processor 202 (and/or co-processor or any other processing circuitry assisting or otherwise associated with the processor) is/are in communication with the memory 204 via a bus for passing information among components of the apparatus 200. In some embodiments, for example, the memory 204 is non-transitory and may include, for example, one or more volatile and/or non-volatile memories. In other words, for example, the memory 204 in some embodiments includes or embodies an electronic storage device (e.g., a computer readable storage medium). In some embodiments, the memory 204 is configured to store information, data, content, applications, instructions, or the like, for enabling the apparatus 200 to carry out various functions in accordance with example embodiments of the present disclosure.

The processor 202 may be embodied in a number of different ways. For example, in some example embodiments, the processor 202 includes one or more processing devices configured to perform independently. Additionally or alternatively, in some embodiments, the processor 202 includes one or more processor(s) configured in tandem via a bus to enable independent execution of instructions, pipelining, and/or multithreading. The use of the terms “processor” and “processing circuitry” should be understood to include a single core processor, a multi-core processor, multiple processors internal to the apparatus 200, and/or one or more remote or “cloud” processor(s) external to the apparatus 200.

In an example embodiment, the processor 202 is configured to execute instructions stored in the memory 204 or otherwise accessible to the processor. Alternatively or additionally, the processor 202 in some embodiments is configured to execute hard-coded functionality. As such, whether configured by hardware or software methods, or by a combination thereof, the processor 202 represents an entity (e.g., physically embodied in circuitry) capable of performing operations according to an embodiment of the present disclosure while configured accordingly. Alternatively or additionally, as another example in some example embodiments, when the processor 202 is embodied as an executor of software instructions, the instructions specifically configure the processor 202 to perform the algorithms embodied in the specific operations described herein when such instructions are executed.

As one particular example embodiment, the processor 202 is configured to perform various operations associated with the process simulation model 108. In some embodiments, the processor 202 includes hardware, software, firmware, and/or a combination thereof, for implementing one or more algorithms to model and simulate the execution of defined process(es) within the process simulation model 108, for example, based on inter-related asset models associated with the industrial plant system 104. For example, in some embodiments, the processor 202 includes hardware, software, firmware, and/or a combination thereof, for performing a variety of calculations associated with the process simulation model 108. In some embodiments, the processor 202 can facilitate storing, sending and/or receiving data associated with the execution of the process simulation model 108 among various components of the system 100. For example, in some embodiments, to facilitate integration of the process simulation model 108, various data associated with performing various functionalities of the process simulation model 108 are stored in the model data storage system 112 and accessible to the process simulation model 108. As such, in some embodiments, the process simulation model 108 can store, send, and/or receive data associated with executing the process simulation model 108 utilizing a single repository (e.g., model data storage system 112). In some embodiments, such data may include current live data generated by the industrial plant system 104, current simulated data (e.g., current model-predicted data generated by a process simulation model 108), historical live data, historical simulated data (e.g., historical model-predicted data generated by a process simulation model). It would be appreciated that these are examples, and not intended to be limiting.

In some embodiments, the apparatus 200 includes input/output circuitry 206 that provides output to the user and, in some embodiments, to receive an indication of a user input. In some embodiments, the input/output circuitry 206 is in communication with the processor 202 to provide such functionality. The input/output circuitry 206 may comprise one or more user interface(s) and in some embodiments includes a display 210 that comprises the interface(s) rendered as a web user interface, an application user interface, a user device, a backend system, or the like. In some embodiments, the input/output circuitry 206 also includes a keyboard, a mouse, a joystick, a touch screen, touch areas, soft keys a microphone, a speaker, and/or other input/output mechanisms. In various examples of the present disclosure, the display 210 may include a liquid crystal display (LCD), a light-emitting diode (LED) display, a plasma (PDP) display, a quantum dot (QLED) display, and/or the like. The processor 202 and/or input/output circuitry 206 may be configured to control one or more functions of one or more user interface elements through computer program instructions (e.g., software and/or firmware) stored on a memory accessible to the processor (e.g., memory 204, and/or the like). In some embodiments, the input/output circuitry 206 includes or utilizes a user-facing application to provide input/output functionality to a client device and/or other display associated with a user.

In some embodiments, the apparatus 200 includes communications circuitry 208. The communications circuitry 208 includes any means such as a device or circuitry embodied in either hardware or a combination of hardware and software that is configured to receive and/or transmit data from/to a network and/or any other device, circuitry, or module in communication with the apparatus 200. In this regard, in some embodiments the communications circuitry 208 includes, for example, a network interface for enabling communications with a wired or wireless communications network. Additionally or alternatively in some embodiments, the communications circuitry 208 includes one or more network interface card(s), antenna(s), bus(es), switch(es), router(s), modem(s), and supporting hardware, firmware, and/or software, or any other device suitable for enabling communications via one or more communications network(s). Additionally or alternatively, the communications circuitry 208 includes circuitry for interacting with the antenna(s) and/or other hardware or software to cause transmission of signals via the antenna(s) or to handle receipt of signals received via the antenna(s). In some embodiments, the communications circuitry 208 enables transmission to and/or receipt of data from user device, one or more asset(s) or accompanying sensor(s), and/or other external computing device in communication with the apparatus 200.

In some embodiments, the apparatus 200 includes process modeling and simulation circuitry 212. The process modeling and simulation circuitry 212 includes hardware, software, firmware, and/or a combination thereof, configured to perform various functionalities associated with the process simulation model 108. In some embodiments, the process modeling and simulation circuitry 212 includes hardware, software, firmware, and/or a combination thereof configured to perform a variety of calculations to simulate the execution of defined process(es) associated with the industrial plant system 104. In some embodiments, the process modeling and simulation circuitry 212 is configured to simulate process(es)/equipment conditions based on first-principles modelling.

In some embodiments, the process modeling and simulation circuitry 212 is configured to perform steady-state simulations. In some embodiments, the process modeling and simulation circuitry 212 is configured to perform dynamic simulations. In some embodiments, the process modeling and simulation circuitry 212 includes hardware, software, firmware, and/or a combination thereof, configured to create or receive and maintain process flow diagrams (e.g., process definition document(s)) which simulate a general flow of plant processes/equipment of the plant embodied by the industrial plant system 104. The process flow diagrams can define asset models and their associated properties utilized by the process simulation model 108 to perform a simulation of the process. In some embodiments, the process flow diagram is configured to model relationships between processes/equipment of the plant. The process flow diagram model, for example, may relate individual processing equipment (e.g., pumps, heat exchangers, distillation unit, etc.) to the performance parameters of overall plant process. In some embodiments, the process simulation model 108 is configured perform one or more of its calculations (e.g., implement one or more algorithms) within the process flow diagram. In some embodiments, the process modeling and simulation circuitry 212 includes a separate processor, specially configured field programmable gate array (FPGA), or a specially programmed application-specific integrated circuit (ASIC).

In some embodiments, the process modeling and simulation circuitry 212 includes hardware, software, firmware, and/or a combination thereof, configured to receive input data from the model data storage system 112, perform, based on the input data, a variety of calculations to simulate the execution of a defined process(es) associated with the industrial plant system 104, and generate predictions (e.g., model-predicted data) that may be used to, for example, monitor, control, and/or optimize the industrial plant system 104 (e.g., plant thereof). In some of the embodiments, substantially all of the data utilized by the process simulation model 108 to perform its various functionalities is stored in the model data storage system 112.

In some embodiments, the apparatus 200 includes process flow diagram conversion circuitry 214. The process flow diagram conversion circuitry 214 includes hardware, software, firmware, and/or a combination thereof, that performs various functionalities associated with generating a process flow diagram. In some embodiments, the process flow diagram conversion circuitry 214 includes hardware, software, firmware, and/or a combination thereof, that convert a first type of process flow diagram into a second, cloud-hosted type of process flow diagram that is formatted to enable web browser access to the process flow diagram, as described in more detail below.

For example, in some embodiments, the process flow diagram conversion circuitry 214 includes hardware, software, firmware, and/or a combination thereof, for receiving a first graphic representation of the process or subprocess and the one or more assets of the process or subprocess.

In some embodiments, the process flow diagram conversion circuitry 214 includes hardware, software, firmware, and/or a combination thereof, for accessing a process simulation model database corresponding to the process or subprocess and the one or more assets of the process or subprocess.

In some embodiments, the process flow diagram conversion circuitry 214 includes hardware, software, firmware, and/or a combination thereof, for converting the first graphic representation into a second graphic representation that is formatted to enable web browser access.

In some embodiments, the process flow diagram conversion circuitry 214 includes hardware, software, firmware, and/or a combination thereof, for storing the second graphic representation in one or more servers or one or more cloud computing devices and providing web browser access to the second graphic representation by one or more user devices.

Having described example systems, apparatuses, data architectures, and model implementations in accordance with the present disclosure, example processes for automatic generation of a process simulation model and associated time-series database within a process simulation system (such as process modeling and simulation system 102) will now be discussed. It will be appreciated that each of the flowcharts depicts an example computer-implemented process that is performable by one or more of the apparatuses, systems, devices, and/or computer program products described herein, for example utilizing one or more of the specially configured components thereof.

The blocks indicate operations of each process. Such operations may be performed in any of a number of ways, including, without limitation, in the order and manner as depicted and described herein. In some embodiments, one or more blocks of any of the processes described herein occur in-between one or more blocks of another process, before one or more blocks of another process, in parallel with one or more blocks of another process, and/or as a sub-process of a second process. Additionally or alternatively, any of the processes in various embodiments include some or all operational steps described and/or depicted, including one or more optional blocks in some embodiments. With regard to the flowcharts illustrated herein, one or more of the depicted block(s) in some embodiments is/are optional in some, or all, embodiments of the disclosure. Optional blocks are depicted with broken (or “dashed”) lines. Similarly, it should be appreciated that one or more of the operations of each flowchart may be combinable, replaceable, and/or otherwise altered as described herein.

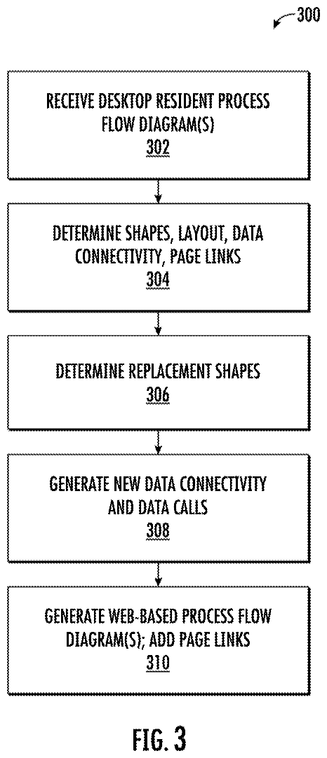

FIG. 3 illustrates a flowchart including example operations of an example process for generating a cloud-hosted process flow diagram that is formatted to enable web browser access to the process flow diagram. Specifically, FIG. 3 illustrates an example computer-implemented process 300. In some embodiments, the process 300 is embodied by computer program code stored on a non-transitory computer-readable storage medium of a computer program product configured for execution to perform the process as depicted and described. Alternatively or additionally, in some embodiments, the process 300 is performed by one or more specially configured computing devices, such as the apparatus 200 alone or in communication with one or more other component(s), device(s), system(s), and/or the like. In this regard, in some such embodiments, the apparatus 200 is specially configured by computer-coded instructions (e.g., computer program instructions) stored thereon, for example in the memory 204 and/or another component depicted and/or described herein and/or otherwise accessible to the apparatus 200, for performing the operations as depicted and described. In some embodiments, the apparatus 200 is in communication with one or more external apparatus(es), system(s), device(s), and/or the like, to perform one or more of the operations as depicted and described. For example, the apparatus 200 in some embodiments is in communication with separate physical component(s) of one or more industrial plants, and/or the like. For purposes of simplifying the description, the process 300 is described as performed by and from the perspective of the apparatus 200.

In some embodiments, the process 300 described in FIG. 3 of converting desktop resident process flow diagrams to web accessible process flow diagrams is performed in batch. That is, a complete set of process flow diagrams is processed simultaneously.

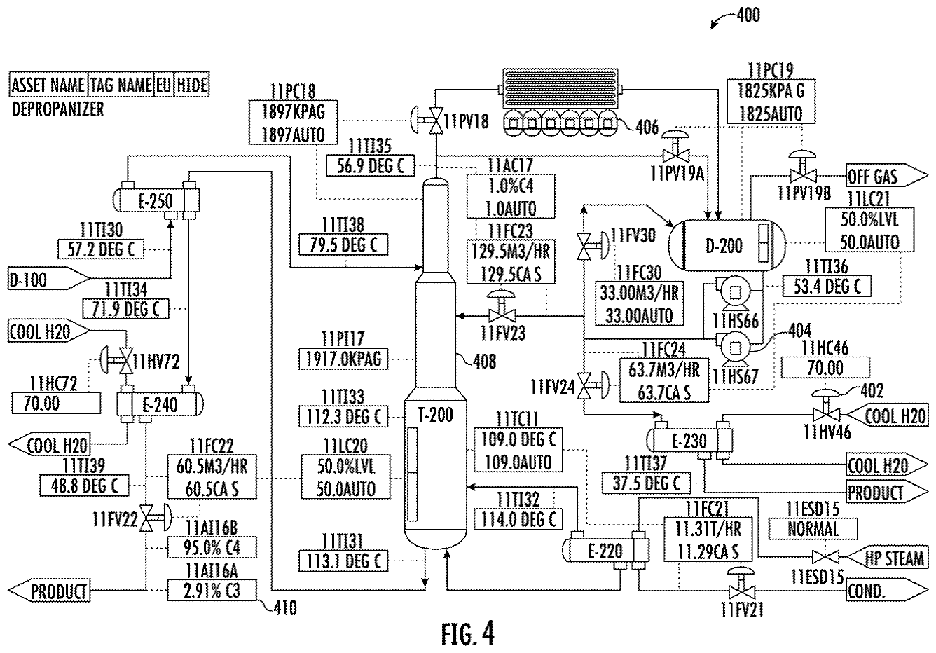

At block 302, a processor (such as, but not limited to, the processor 202 of the apparatus 200 described above in connection with FIG. 2, along with the process flow diagram conversion circuitry 214) receives a first process flow diagram that is a graphic representation of a process flow in an industrial plant, such as process flow diagram 400 of FIG. 4. In some embodiments, the first process flow diagram is a training process flow diagram from an HMI (human-machine interface) of a desktop-bound training simulation system. Such a training process flow diagram may be linked to a local (i.e., desktop resident) process simulation model database. In some embodiments, the first process flow diagram comprises a plurality of first process flow diagrams. In some embodiments, the first process flow diagram comprises a plurality of pages or sheets. In some embodiments, there are one or more links between at least two pages or sheets of a multi-page or multi-sheet first process flow diagram. In some embodiments, the first process flow diagram is not formatted to enable web browser access or display. In some embodiments, the first process flow diagram comprises a .htm file.

While embodiments of the disclosure are described herein as converting a process flow diagram to a cloud-hosted, web-accessible process flow diagram, it should be appreciated that such a conversion will typically involve multiple (and potentially large numbers of) process flow diagrams.

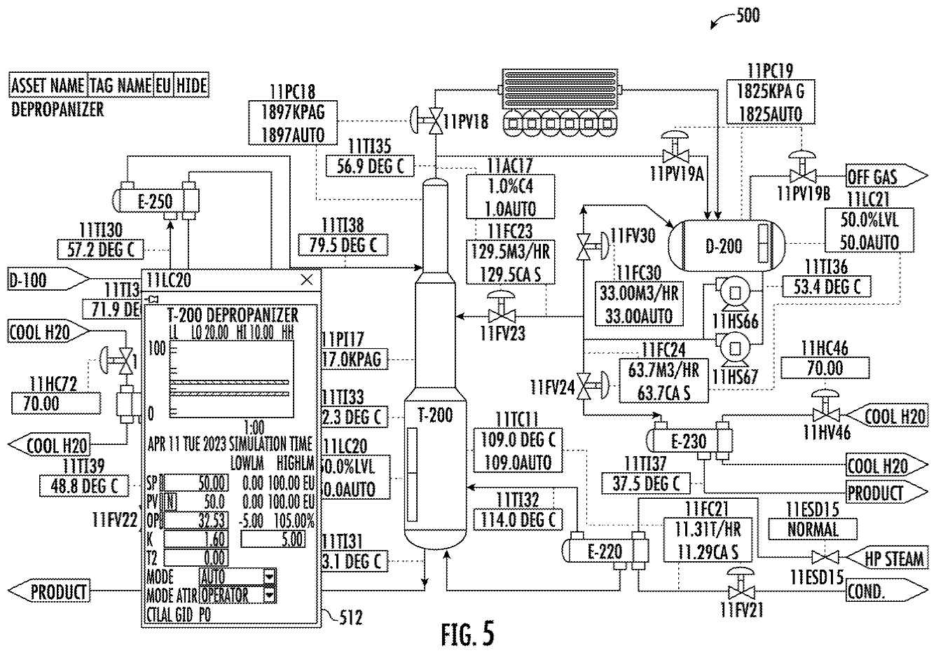

As seen in FIG. 4, the first process flow diagram typically comprises one or more graphical icons representing specific assets and/or processes within the industrial plant. Illustrated in FIG. 4, as an example, are a plurality of graphical icons representing control valves 402, pumps 404, fans 406, distillation columns 408, and data displays 410 that display one or more attribute values related to a corresponding asset. In some embodiments, the first process flow diagram comprises one or more links to one or more other pages or other first process flow diagrams. In some embodiments, the first process flow diagram may comprise one or more faceplates that display additional details (such as additional attribute values) related to a corresponding asset. FIG. 5 is an alternative view of the graphical representation of FIG. 4, highlighting a pop-up faceplate 512. In some embodiments, key equipment and controllers may have supplementary data available through such faceplates, allowing user interaction with the model.

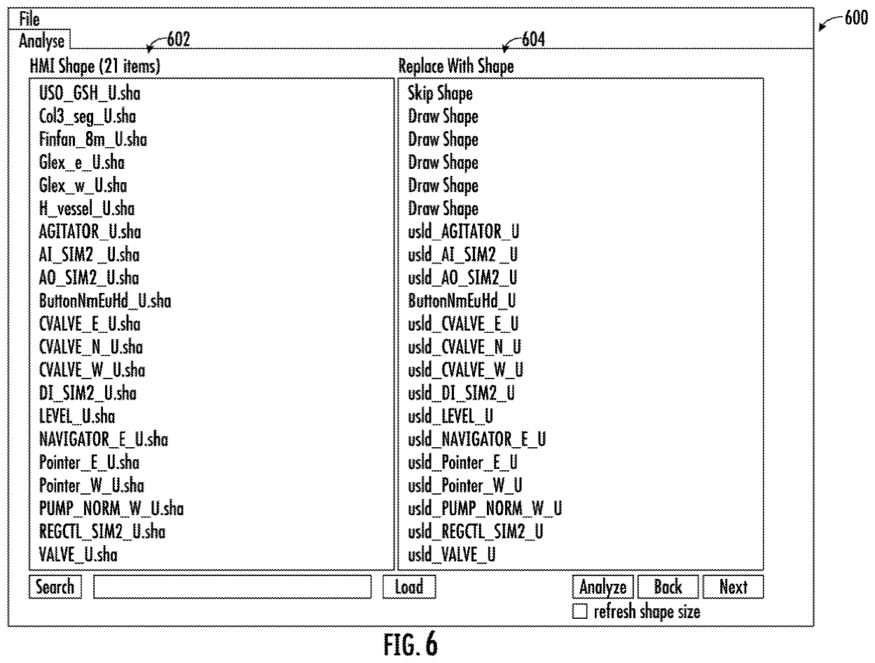

Other process flow diagrams may depict icons representing different valve types (check valves, control valves, shut-off valves of various designs), compressors, turbines, vessels, heat exchangers, or any other process equipment or combinations thereof. In addition, since this process equipment comes in many different designs, different icons may be used to represent different classes of a particular equipment item. For example, distillation column 408 (labeled “T-200”) is depicted with an icon showing three different diameters to reflect the actual equipment swaging. Other columns with a uniform diameter may be depicted accordingly. Additionally different Training Simulator and DCS vendors use different libraries of shapes in developing their flowsheets. The cloud hosted shape library may emulate these variations, offering a multiplicity of shapes for a particular equipment or replacing with a “standard” shape at the user's discretion. The shape mapping in FIG. 6 (described below) summarizes and defines these choices.

Returning to FIG. 3, at block 304, a processor (such as, but not limited to, the processor 202 of the apparatus 200 described above in connection with FIG. 2, along with the process flow diagram conversion circuitry 214) analyzes the first process flow diagram received at block 302 and determines the shapes (i.e., the graphical icons) in the first process flow diagram, the layout of the shapes (i.e., where on the page each shape resides), the data connectivity of each shape (where appropriate), pop-up faceplates, and any embedded connectivity links between multiple pages or sheets within a set. In some embodiments, the processor identifies the file type of the first process flow diagram (e.g., an .htm file) to enable determination of the shapes, layout, etc. in the first process flow diagram as the file type typically dictates certain characteristics of the diagram (e.g., naming conventions, etc.). In some embodiments, determining the data connectivity of the shapes involves determining the links to specific assets and attributes in a local (i.e., desktop resident) database.

At block 306, a processor (such as, but not limited to, the processor 202 of the apparatus 200 described above in connection with FIG. 2, along with the process flow diagram conversion circuitry 214) determines replacement shapes for each of the shapes determined in the first process flow diagram. In some embodiments, one or more predetermined libraries of replacement shapes is/are provided, such that the replacement shapes are determined from the library(ies) of replacement shapes. In some embodiments, a different library of replacement shapes is available for each different file/graphic type of the first process flow diagram. In some embodiments, a single library of replacement shapes comprises multiple lists of shapes for multiple different file/graphic types of the first process flow diagram. In some embodiments, the library of replacement shapes includes a plurality of different shapes of a first, non-web-accessible type, each with a corresponding replacement shape of a second, web-accessible type. In some embodiments, the replacements shapes are predetermined based on one or more matching characteristics to a corresponding shape of a first, non-web-accessible type. In some embodiments, the one or more matching characteristics include, but are not limited to, asset type, size, color/grayscale, and/or type of industrial process (chemical industrial plant, distillery, oil refinery, etc.).

Referring to FIG. 6, an example library 600 of replacement shapes is illustrated. FIG. 6 illustrates an example mapping of shapes between a source shape library (HMI shapes) and the cloud hosted shape library. Where possible this mapping is preferably an automated process, and this view is presented for verification. In some embodiments, missing shapes in the cloud hosted shape library are identified allowing for a suitable replacement to be created or identified. In the example of FIG. 6, a list 602 of original shapes that have been determined at block 302 from the first process flow diagram is illustrated on the left side of the figure. In the illustrated example there are twenty-one shapes in the list of original shapes, but typically a much greater number of shapes would be determined and replaced. On the right side of the figure, a list of replacement, web-accessible shapes 604 is illustrated. In the illustrated example, the list of replacement shapes 604 comprises a corresponding replacement shape for each original shape in the list 602 of original shapes.

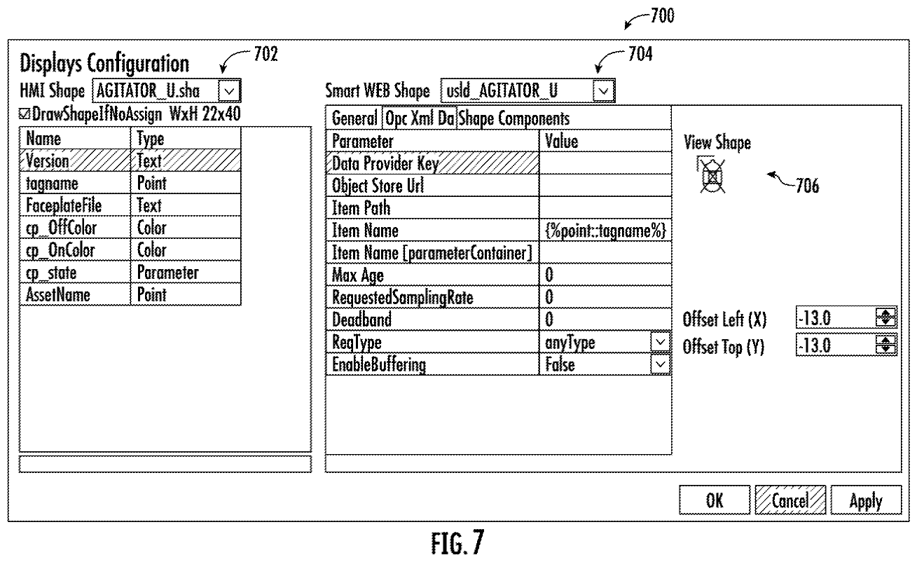

In some embodiments, the list of replacement shapes is user-editable such that a user can change the suggested replacement shape to a different replacement shape. In some embodiments, a user can select one of the pairs of original/replacement shapes to see details of the original and replacement shapes. Referring to FIG. 7, an example detail display page 700 is illustrated. In the example of FIG. 7, one or more details 702 of the original shape (“AGITATOR_U.sha” in the illustrated example) is shown and one or more details 704 of the suggested replacement shape (“usld.AGITATOR_U” in the illustrated example) is shown. In some embodiments, a thumbnail image 706 of the original shape and/or the suggested replacement shape is shown. In some embodiments, a user can select a different replacement shape if desired.

In some embodiments, there may not be a suggested replacement shape for every original shape. In such a situation, there may be one or more blank spaces in the list of replacement shapes 604 in FIG. 6. In some embodiments, a user is prompted to identify a replacement shape, such as by browsing to and selecting a replacement shape from some other source. In some embodiments, a user is able to skip identifying a replacement shape for any blank spaces, in which case the cloud-hosted, web-accessible process flow diagram will be generated with one or more shapes missing. In some embodiments, the generated cloud-hosted, web-accessible process flow diagram is user-editable to add any missing shapes after the cloud-hosted, web-accessible process flow diagram is generated.

Returning to FIG. 3, at block 308, a processor (such as, but not limited to, the processor 202 of the apparatus 200 described above in connection with FIG. 2, along with the process flow diagram conversion circuitry 214) generates new data connectivity for the replacement shapes (where appropriate) and generates data calls for the new data connections. Some or all of the shapes of the first flowsheet have links to specific assets and attributes in a local (i.e., desktop resident) database, as determined at block 304. In some embodiments, the links in the generated flowsheet are changed to point to a cloud-hosted TSDB. In some embodiments, a user identifies the cloud-hosted TSDB by browsing to and selecting the TSDB in a file directory. In some embodiments, the asset and attribute names are consistent in the local database and the cloud-hosted TSDB, such that the shapes, data displays, and faceplates in the generated flowsheet are automatically linked to the appropriate asset/attribute once the link to the cloud-hosted TSDB is established. In some embodiments, the asset and attribute names are not consistent in the local database and the cloud-hosted TSDB, such that data connectivity needs to be updated in the generated flowsheet to use the asset and attribute names as they appear in the cloud-hosted TSDB. With the cloud-hosted TSDB identified, conventional API (application program interface) calls are generated to extract the data from the cloud-hosted TSDB corresponding to each shape in the generated flowsheet.

In some embodiments, by linking the generated flowsheet to the cloud-hosted TSDB it is possible to display both live data from the industrial plant and calculated data from the process simulation model, as the TSDB often includes both types of data. If it is desired to display data (whether live data from the industrial plant and calculated data from the process simulation model) that was not linked to the flowsheet received at block 302, links to the additional data will need to be generated and added.

At block 310, a processor (such as, but not limited to, the processor 202 of the apparatus 200 described above in connection with FIG. 2, along with the process flow diagram conversion circuitry 214) generates the web-accessible process flow diagrams, one for each of the first process flow diagrams received, using the replacement shapes and the updated data connectivity. In some embodiments, all of the web-accessible process flow diagrams are generated in a batch. In some embodiments, the web-accessible process flow diagrams are generated in a scalable vector graphics (.svg) format. In some embodiments, each of the web-accessible process flow diagrams is given a unique addressable location, such as a uniform resource locator (URL). Where needed, links from one web-accessible process flow diagram to another web-accessible process flow diagram are created and embedded in the appropriate web-accessible process flow diagram. In some embodiments, such links between web-accessible process flow diagrams are in the form of an embedded URL. The generated web-accessible process flow diagrams are saved to one or more servers or one or more cloud computing devices and web browser access to the web-accessible process flow diagrams is provided.

In some embodiments, the cloud-hosted, web-accessible process flow diagram generated at block 310 is user-editable to add any missing shapes, change shapes, change layout, etc.

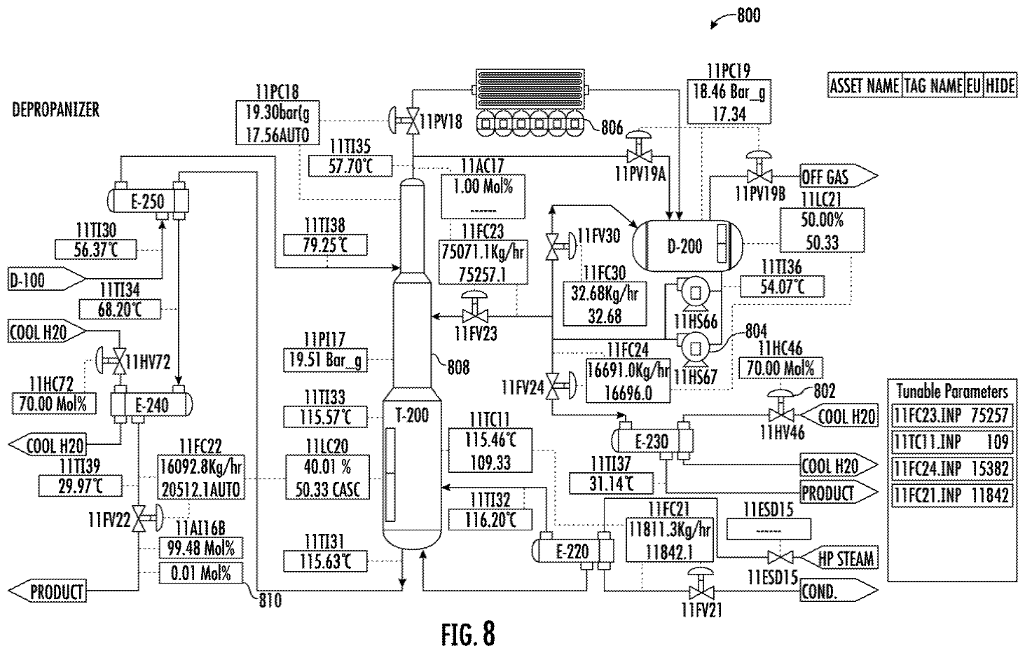

Referring now to FIG. 8, an example generated web-accessible process flow diagram 800 is illustrated. As is seen comparing the process flow diagram 400 of FIG. 4 to the process flow diagram of FIG. 8, the example generated web-accessible process flow diagram 800 is not identical to the received process flow diagram 400 but has essentially the same layout and the same (although not identical) graphical icons and data displays. Illustrated in FIG. 8, as an example, are a plurality of graphical icons representing control valves 802, pumps 804, fans 806, distillation columns 808, and data displays 810 that display one or more attribute values related to a corresponding asset.

### CONCLUSION

Although an example processing system has been described above, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer storage medium for execution by, or to control the operation of, information/data processing apparatus. Alternatively, or in addition, the program instructions can be encoded on an artificially generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a repository management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client computer having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method for generating a process flow diagram that digitally represents one or more assets of a process or subprocess within an industrial environment, the method comprising:
receiving a first graphic representation of the process or subprocess and the one or more assets of the process or subprocess;
accessing a data model database corresponding to the process or subprocess and the one or more assets of the process or subprocess, the data model database comprising a time series database comprising values for one or more attributes corresponding to the one or more assets of the process or subprocess at a plurality of different times;
converting the first graphic representation into a second graphic representation of the process or subprocess and the one or more assets of the process or subprocess, the second graphic representation linked to the data model database and including values from the data model database for one or more of the attributes corresponding to the one or more assets of the process or subprocess, the second graphic representation formatted to enable web browser access; and
storing the second graphic representation in one or more servers or one or more cloud computing devices and providing web browser access to the second graphic representation by one or more user devices.

2. The method of claim 1, wherein the one or more assets of the process or subprocess comprise equipment, streams, measurement instruments, calculated values, inputs and/or outputs.

3. The method of claim 1, wherein the first graphic representation comprises a training simulator graphic representation of the process or subprocess or a distributed control system console graphic representation of the process or subprocess.

4. The method of claim 1, wherein the displayed values from the data model database comprise live data from the industrial environment and/or calculated data.

5. The method of claim 1, wherein at least some of the one or more attributes enable preprocessing calculations, postprocessing calculations, storing inputs to the preprocessing and/or postprocessing calculations, storing results from the preprocessing and/or postprocessing calculations, measurement values from the industrial environment, parameter values to support the preprocessing and/or postprocessing calculations, and/or simulation results.

6. The method of claim 1, wherein the second graphic representation is linked to the data model database via an application program interface.

7. The method of claim 1, wherein the second graphic representation is user-editable.

8. An apparatus for generating a process flow diagram that digitally represents one or more assets of a process or subprocess within an industrial environment, the apparatus comprising at least one processor and at least one non-transitory memory comprising program code, wherein the at least one non-transitory memory and the program code are configured to, with the at least one processor, cause the apparatus to at least:
receive a first graphic representation of the process or subprocess and the one or more assets of the process or subprocess;
access a data model database corresponding to the process or subprocess and the one or more assets of the process or subprocess, the data model database comprising a time series database comprising values for one or more attributes corresponding to the one or more assets of the process or subprocess at a plurality of different times;
convert the first graphic representation into a second graphic representation of the process or subprocess and the one or more assets of the process or subprocess, the second graphic representation linked to the data model database and including values from the data model database for one or more of the attributes corresponding to the one or more assets of the process or subprocess, the second graphic representation formatted to enable web browser access; and
store the second graphic representation in one or more servers or one or more cloud computing devices and provide web browser access to the second graphic representation by one or more user devices.

9. The apparatus of claim 8, wherein the one or more assets of the process or subprocess comprise equipment, streams, measurement instruments, calculated values, inputs and/or outputs.

10. The apparatus of claim 8, wherein the first graphic representation comprises a training simulator graphic representation of the process or subprocess or a distributed control system console graphic representation of the process or subprocess.

11. The apparatus of claim 8, wherein the displayed values from the data model database comprise live data from the industrial environment and/or calculated data.

12. The apparatus of claim 8, wherein at least some of the one or more attributes enable preprocessing calculations, postprocessing calculations, storing inputs to the preprocessing and/or postprocessing calculations, storing results from the preprocessing and/or postprocessing calculations, measurement values from the industrial environment, parameter values to support the preprocessing and/or postprocessing calculations, and/or simulation results.

13. The apparatus of claim 8, wherein the second graphic representation is linked to the data model database via an application program interface.

14. The apparatus of claim 8, wherein the second graphic representation is user-editable.

15. A computer program product for generating a process flow diagram that digitally represents one or more assets of a process or subprocess within an industrial environment, the computer program product comprising at least one non-transitory computer-readable storage medium having computer-readable program code portions stored therein, the computer-readable program code portions comprising an executable portion configured to:
receive a first graphic representation of the process or subprocess and the one or more assets of the process or subprocess;
access a data model database corresponding to the process or subprocess and the one or more assets of the process or subprocess, the data model database comprising a time series database comprising values for one or more attributes corresponding to the one or more assets of the process or subprocess at a plurality of different times;
convert the first graphic representation into a second graphic representation of the process or subprocess and the one or more assets of the process or subprocess, the second graphic representation linked to the data model database and including values from the data model database for one or more of the attributes corresponding to the one or more assets of the process or subprocess, the second graphic representation formatted to enable web browser access; and
store the second graphic representation in one or more servers or one or more cloud computing devices and provide web browser access to the second graphic representation by one or more user devices.

16. The computer program product of claim 15, wherein the one or more assets of the process or subprocess comprise equipment, streams, measurement instruments, calculated values, inputs and/or outputs.

17. The computer program product of claim 15, wherein the first graphic representation comprises a training simulator graphic representation of the process or subprocess or a distributed control system console graphic representation of the process or subprocess.

18. The computer program product of claim 15, wherein the displayed values from the data model database comprise live data from the industrial environment and/or calculated data.

19. The computer program product of claim 15, wherein at least some of the one or more attributes enable preprocessing calculations, postprocessing calculations, storing inputs to the preprocessing and/or postprocessing calculations, storing results from the preprocessing and/or postprocessing calculations, measurement values from the industrial environment, parameter values to support the preprocessing and/or postprocessing calculations, and/or simulation results.

20. The computer program product of claim 15, wherein the second graphic representation is linked to the data model database via an application program interface.
